(19) United States
(12) Patent Application Publication
(10) Pub. No.: US 2015/0125735 A1
(43) Pub. Date: May 7, 2015

(54) RECHARGEABLE LITHIUM BATTERY

(71) Applicant: SAMSUNG SDI CO., LTD., Yongin-si (KR)

(72) Inventors: Tae-Hyun Bae, Yongin-si (KR); Woo-Cheol Shin, Yongin-si (KR); Sang-Hyun Eom, Yongin-si (KR); Myung-Hoon Kim, Yongin-si (KR); Seung-Tae Lee, Yongin-si (KR); Ae-Ran Kim, Yongin-si (KR); Dong-Myung Choi, Yongin-si (KR)

(21) Appl. No.: 14/494,541

(22) Filed: Sep. 23, 2014

(30) Foreign Application Priority Data
Nov. 4, 2013 (KR) 10-2013-0133111

(51) Int. Cl. H01M 10/0525; H01M 2/16; H01M 10/0567; H01M 4/134

(52) U.S. Cl. CPC H01M 10/0525; H01M 4/134; H01M 2/1686; H01M 10/0567; H01M 2300/0025
USPC 429/144; 429/188; 429/200

(57) ABSTRACT

A rechargeable lithium battery includes: a negative electrode including a negative active material; a positive electrode; a separator interposed between the negative electrode and the positive electrode; and an electrolyte solution including an additive, wherein the negative active material includes a Si-based material, the Si-based material is included in an amount from about 1 to about 70 wt % based on total amount of the negative active material, and the additive includes fluoroethylene carbonate and a compound represented by the following Chemical Formula 1.

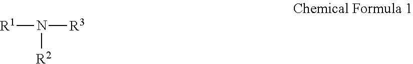

In the above Chemical Formula 1, R¹ to R³ are each independently a substituted or unsubstituted C2 to C5 alkyl group.

### CROSS-REFERENCE TO RELATED APPLICATIONS

This application claims priority to and the benefit of Korean Patent Application No. 10-2013-0133111, filed in the Korean Intellectual Property Office on Nov. 4, 2013, the entire content of which is incorporated herein by reference.

### BACKGROUND

1. Field

A rechargeable lithium battery is disclosed.

2. Description of the Related Art

A lithium polymer battery may be manufactured to have various shapes, for example, a thin film shape and accordingly, may be applied to a small IT device such as a smart phone, a tablet PC, a net book, or the like.

As these IT devices gradually require higher and higher performance, the battery used therein is required to have a high-capacity. As the rechargeable lithium battery is required to have a high capacity, graphite, as a negative electrode material, may not sufficiently realize the high-capacity as required for the rechargeable lithium battery.

Accordingly, a silicon-based active material has drawn attention as a negative electrode material due to higher charge and discharge capacity than the graphite. However, the silicon-based active material has a problem of sharp cycle-life deterioration, since an electrolyte solution is exhausted due to a reaction of silicon in the negative electrode with the electrolyte solution.

### SUMMARY

An aspect according to one embodiment of present invention is directed toward a rechargeable lithium battery having improved cycle-life characteristics at room temperature and at high temperatures during high voltage charge.

According to one embodiment of the present invention, a rechargeable lithium battery includes: a negative electrode including a negative active material, the negative active material including about 1 to about 70 wt % of a Si-based material based on a total amount of the negative active material; a positive electrode including a positive active material; a separator between the negative electrode and the positive electrode; and an electrolyte solution including a lithium salt, an organic solvent and an additive, the additive including fluoroethylene carbonate and a compound represented by Chemical Formula 1.

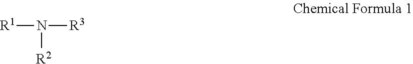

where R¹ to R³ are each independently a substituted or unsubstituted C2 to C5 alkyl group.

The compound represented by Chemical Formula 1 may be included in an amount from about 0.1 to about 10 parts by weight based on 100 parts by weight of the organic solvent.

The fluoroethylene carbonate may be included in an amount from about 1 to 10 parts by weight based on 100 parts by weight of the organic solvent.

The additive may further include LiB(C₂O₄)F₂ (lithium difluorooxalatoborate, LiFOB), and the LiB(C₂O₄)F₂ may be included in an amount from about 0.1 to about 5 parts by weight based on 100 parts by weight of the organic solvent.

The Si-based material may include Si; SiOx where x is greater than zero and less than or equal to two; a Si-M alloy wherein M is an element selected from an alkali metal, an alkaline-earth metal, a Group 13 to 16 element other than Si, a transition metal, a rare earth element, or a combination thereof; a Si—C composite; or a combination thereof.

The separator may include a substrate and a coating layer on at least one side of the substrate and including a polymer.

The polymer may include polyvinylidene fluoride (PVdF), a polyvinylidene fluoride-hexafluoropropylene (PVdF-HFP) copolymer, or a combination thereof.

The coating layer may further include an inorganic material, and the inorganic material may include Al₂O₃, MgO, TiO₂, Al(OH)₃, Mg(OH)₂, Ti(OH)₄, or a combination thereof.

The rechargeable lithium battery may be configured to be charged to a voltage from about 4.0 to about 4.45 V.

Other embodiments are included in the following detailed description.

A rechargeable lithium battery having improved cycle-life characteristics at room temperature and at high temperatures during high voltage charge may be provided.

### BRIEF DESCRIPTION OF THE DRAWINGS

FIG. 1 is a schematic view showing a rechargeable lithium battery manufactured according to one embodiment.

FIG. 2 is a graph showing a cyclic voltammetry analysis of a rechargeable lithium battery cell manufactured according to Example 1.

FIG. 3 is a graph showing cyclic voltammetry analysis of a rechargeable lithium battery cell manufactured according to Comparative Example 1.

FIG. 4 is a graph showing high temperature cycle-life characteristics of the rechargeable lithium battery cells manufactured according to Examples 1 and 2 and Comparative Example 1.

FIG. 5 is a graph showing high temperature cycle-life characteristics of the rechargeable lithium battery cells manufactured according to Examples 1 and 3 and Comparative Examples 1 and 2.

### DETAILED DESCRIPTION

Hereinafter, embodiments are described in more detail. However, these embodiments are examples only, and this disclosure is not limited thereto. Expressions such as “at least one of,” when preceding a list of elements, modify the entire list of elements and do not modify the individual elements of the list. Further, the use of “may” when describing embodiments of the present invention refers to “one or more embodiments of the present invention.”

As used herein, when a definition is not otherwise provided, the term “substituted” may refer to a group or compound with at least one hydrogen atom substituted with a substituent selected from a halogen (F, Br, Cl or I), a hydroxyl group, an alkoxy group, a nitro group, a cyano group, an amino group, an azido group, an amidino group, a hydrazino group, a hydrazono group, a carbonyl group, a carbamyl group, a thiol group, an ester group, a carboxyl group or a salt thereof, a sulfonic acid group or a salt thereof, a phosphoric acid or a salt thereof, a C1 to C20 alkyl group, a C2 to C20 alkenyl group, a C2 to C20 alkynyl group, a C6 to C30 aryl group, a C7 to C30 arylalkyl group, a C1 to C4 alkoxy group, a C1 to C20 heteroalkyl group, a C3 to C20 heteroarylalkyl group, a C3 to C30 cycloalkyl group, a C3 to C15 cycloalkenyl group, a C6 to C15 cycloalkynyl group, a C2 to C20 heterocycloalkyl group, or a combination thereof.

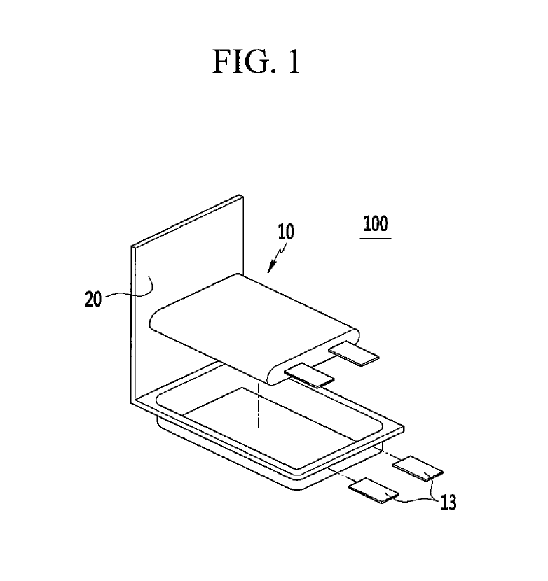

A rechargeable lithium battery according to one embodiment is described by referring to FIG. 1.

FIG. 1 is a schematic view showing a rechargeable lithium battery according to one embodiment.

Referring to FIG. 1, a rechargeable lithium battery 100 according to one embodiment includes an electrode assembly 10, a battery case 20 housing the electrode assembly 10, and an electrode tab 13 for connecting the electrode assembly 10 with a device and provide the electrical current from the electrode assembly 10 to such a device. In this embodiment, the battery case 20 is folded on itself and sealed. In addition, an electrolyte solution is injected into the battery case 20 housing the electrode assembly 10.

The electrode assembly 10 includes a positive electrode, a negative electrode facing the positive electrode and a separator interposed between the negative electrode and the positive electrode, wherein the electrolyte solution is impregnated in the positive electrode, the negative electrode and the separator.

The electrolyte solution may include a lithium salt, an organic solvent, and an additive.

The additive may include fluoroethylene carbonate and a compound represented by the following Chemical Formula 1.

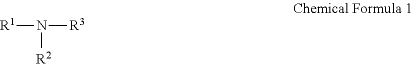

In the above Chemical Formula 1, R¹ to R³ may be each independently a substituted or unsubstituted C2 to C5 alkyl group.

The compound represented by the above Chemical Formula 1 binds with HF generated in the electrolyte solution and thereby a reaction of the electrolyte solution with the negative active material, and specifically the Si-based material may be suppressed, and thus the battery performance is improved.

A lithium salt of the electrolyte solution may react with the Si-based material of the negative electrode on the surface of the Si-based material as follows. The lithium salt is illustrated by using LiPF₆ as an example, and the Si-based material is illustrated by using SiO₂ as an example, but the lithium salt and the Si-based material are respectively not limited thereto.

1) LiPF₆ (Li⁺+PF₆⁻)→LiF+PF₅

2) PF₅+H₂O→PF₃O+2HF

3) HF+Li+e⁻→LiF+½H₂

4) 2HF+Li₂CO₃→2LiF+H₂CO₃

5) SiO₂+4HF→SiF₄+2H₂O

6) SiO₂+6HF→H₂SiF₆+2H₂O

The electrolyte solution reacts with the Si-based material of the negative electrode through this mechanism and may deteriorate the battery performance. According to one embodiment, a compound represented by the above Chemical Formula 1 is bound with HF in the electrolyte solution and thus, suppresses a reaction of the HF with the Si-based material as shown in the reactions 5) and 6) and thus, may improve cycle-life characteristics at room temperature and at high temperatures.

In the above Chemical Formula 1, when the alkyl group of R¹ to R³ has about 2 to about 5 carbons, the compound may more easily bind with the HF and may better suppress a reaction of the electrolyte solution with the Si-based material.

The compound represented by the above Chemical Formula 1 may be included in an amount from about 0.1 to about 10 parts by weight, for example, about 0.2 to about 3 parts by weight based on 100 parts by weight of the organic solvent. In one embodiment, when the compound represented by the above Chemical Formula 1 is included within the range, the compound is more easily bonded with the HF and better suppresses a reaction of the electrolyte solution with the Si-based material of the negative electrode.

The fluoroethylene carbonate is decomposed earlier than other carbonates such as ethylene carbonate used as an organic solvent and may form a stable SEI film on the surface of the negative electrode and thus, improve the performance of a rechargeable lithium battery.

The fluoroethylene carbonate may be included in an amount from about 1 to about 10 parts by weight, for example, about 5 to about 7 parts by weight based on 100 parts by weight of the organic solvent. In one embodiment, when the fluoroethylene carbonate is included within the range, cycle-life characteristics of a rechargeable lithium battery are improved at room temperature and at high temperatures without capacity deterioration.

The additive may further include LiB(C₂O₄)F₂ (lithium difluorooxalatoborate, LiFOB). The LiB(C₂O₄)F₂ has low resistance against the Si-based material of the negative electrode and may improve cycle-life characteristics more at room temperature and at high temperatures.

The LiB(C₂O₄)F₂ may be included in an amount from about 0.1 to about 5 parts by weight, for example, about 1 to about 3 parts by weight based on 100 parts by weight of the organic solvent. In one embodiment, when the LiB(C₂O₄)F₂ is included within the range, cycle-life characteristics at room temperature and at high temperatures are improved without capacity deterioration.

The additive may further include vinylethylene carbonate, propane sultone, succinonitrile, adiponitrile, or a combination thereof in addition to the above additive.

The organic solvent serves as a medium for transmitting ions taking part in the electrochemical reaction of a battery. The organic solvent may be selected from a carbonate-based, ester-based, ether-based, ketone-based, alcohol-based, or aprotic solvent.

The carbonate-based solvent may include, for example, dimethyl carbonate (DMC), diethyl carbonate (DEC), dipropyl carbonate (DPC), methylpropyl carbonate (MPC), ethylpropyl carbonate (EPC), ethylmethyl carbonate (EMC), ethylene carbonate (EC), propylene carbonate (PC), butylene carbonate (BC), or the like.

When linear carbonate compounds and cyclic carbonate compounds are mixed, an organic solvent having high dielectric constant and low viscosity can be provided. The cyclic carbonate and the linear carbonate may be mixed together in a volume ratio from about 1:1 to about 1:9.

The ester-based solvent may include, for example, methylacetate, ethylacetate, n-propylacetate, dimethylacetate, methylpropionate, ethylpropionate, γ-butyrolactone, decanolide, valerolactone, mevalonolactone, caprolactone, or the like. The ether solvent may include, for example, dibutylether, tetraglyme, diglyme, dimethoxyethane, 2-methyltetrahydrofuran, tetrahydrofuran, or the like; and the ketone-based solvent may include, for example, cyclohexanone, or the like. The alcohol-based solvent may include, for example, ethyl alcohol, isopropyl alcohol, or the like.

The organic solvent may be used singularly or in a mixture. When the organic solvent is used in a mixture, the mixing ratio may be controlled in accordance with a desirable battery performance.

The lithium salt is dissolved in an organic solvent. The lithium salt supplies lithium ions in a battery, enables the basic operation of the rechargeable lithium battery, and improves the lithium ion transportation between the positive and negative electrodes therein.

The lithium salt may include LiPF₅, LiBF₄, LiSbF₆, LiAsF₆, LiN(SO₃C₂F₅)₂, LiC₄F₉SO₃, LiClO₄, LiAlO₂, LiAlCl₄, LiN(CₓF₂ₓ₊₁SO₂)(C_{y}F_{2y+1}SO₂) (where x and y are natural numbers), LiCl, LiI, LiB(C₂O₄)₂ (lithiumbisoxalatoborate (LiBOB)) or a combination thereof.

The lithium salt may be used in a concentration from about 0.1 M to about 2.0 M. In one embodiment, when the lithium salt is included within the above concentration range, an electrolyte has improved performance and lithium ion mobility due to the enhanced electrolyte conductivity and viscosity.

The negative electrode includes a negative current collector and a negative active material layer disposed thereon.

The negative current collector may be a copper foil, a nickel foil, a stainless steel foil, a titanium foil, a nickel foam, a copper foam, a polymer substrate coated with a conductive metal, or a combination thereof, but is not limited thereto.

The negative active material layer may include a negative active material, a binder, and optionally a conductive material.

The negative active material may include a Si-based material. The above electrolyte solution additive suppresses a reaction between the Si-based material and the electrolyte solution and thus the battery performance may be improved.

The Si-based material may include Si, SiOx (0<x≦2), a Si-M alloy (where M is an element selected from an alkali metal, an alkaline-earth metal, a Group 13 to 16 element other than Si, a transition metal, a rare earth element, or a combination thereof), a Si—C composite, or a combination thereof. The element M may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof.

The Si-based material may be included in an amount from about 1 to about 70 wt %, for example, about 7 to about 20 wt % based on a total amount of the negative active material layer. In one embodiment, when the Si-based material is included within the above range, the above electrolyte solution additive does not need to be used in a large amount, and thus high-capacity and cycle-life characteristics of a battery are improved.

The negative active material may further include a carbon-based material, a lithium metal alloy, a transition metal oxide, or a combination thereof, in addition to the Si-based material.

The carbon-based material may include crystalline carbon, amorphous carbon, or a combination thereof. The crystalline carbon may include graphite, and examples of the graphite may include irregularly-shaped, sheet-shaped, flake-shaped, a spherical-shaped or fiber-shaped natural graphite or artificial graphite. The amorphous carbon may include soft carbon or hard carbon, a mesophase pitch carbonized product, fired coke, or the like.

The lithium metal alloy may be an alloy of lithium and a metal selected from Na, K, Rb, Cs, Fr, Be, Mg, Ca, Sr, Si, Sb, Pb, In, Zn, Ba, Ra, Ge, Al, or Sn.

The transition metal oxide may be vanadium oxide, lithium vanadium oxide, or the like.

The binder improves the binding properties of the negative active material particles with one another and with a current collector, and examples thereof may be polyvinyl alcohol, carboxylmethyl cellulose, hydroxypropyl cellulose, polyvinylchloride, carboxylated polyvinylchloride, polyvinyifluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The conductive material improves the conductivity of an electrode. Any suitable electrically conductive material may be used as a conductive material, unless it causes a chemical change. Examples thereof may be a carbon-based material such as natural graphite, artificial graphite, carbon black, acetylene black, ketjen black, a carbon fiber or the like; a metal-based material such as a metal powder or a metal fiber of copper, nickel, aluminum, silver, or the like; a conductive polymer such as a polyphenylene derivative or the like; or a mixture thereof.

The positive electrode may include a positive current collector and a positive active material layer formed on the positive current collector. The positive active material layer includes a positive active material, a binder, and optionally a conductive material.

The positive current collector may be Al (aluminum), but is not limited thereto.

The positive active material may be a compound capable of intercalating and deintercallating lithium. In one embodiment, at least one composite oxide of lithium and a metal of cobalt, manganese, nickel, or a combination thereof may be used, and examples thereof may be a compound represented by one of the following chemical formulae:

LiₐA_{1-b}L_{b}D₂ (wherein, in the above chemical formula, 0.90≦a≦1.8 and 0≦b≦0.5); LiₐE_{1-b}L_{b}O_{2-c}D_{c} (wherein, in the above chemical formula, 0.90≦a≦1.8, 0≦b≦0.5, 0≦c≦0.05); LiE_{2-b}L_{b}O_{4-c}D_{c} (wherein, in the above chemical formula, 0≦b≦0.5, 0≦c≦0.05); LiₐNi_{1-b-c}Co_{b}L_{c}D_{α} (wherein, in the above chemical formula, 0.90≦a≦1.8, 0≦b≦0.5, 0≦c≦0.05, 0<α≦2); LiₐNi_{1-b-c}Co_{b}L_{c}O_{2-α}R_{α} (wherein, in the above chemical formula, 0.90≦a≦1.8, 0≦b≦0.5, 0≦c≦0.05, 0<α<2); LiₐNi_{1-b-c}Co_{b}L_{c}O_{2-α}R₂ (wherein, in the above chemical formula, 0.90≦a≦1.8, 0≦b≦0.5, 0≦c≦0.05, 0<α<2); LiₐNi_{1-b-c}Mn_{b}L_{c}D_{α} (wherein, in the above chemical formula, 0.90≦a≦1.8, 0≦b≦0.5, 0≦c≦0.05, 0<α≦2); LiₐNi_{1-b-c}Mn_{b}L_{2-α}R_{α} (wherein, in the above chemical formula, 0.90≦a≦1.8, 0≦b≦0.5, 0≦c≦0.05, 0<α<2); LiₐNi_{1-b-c}Mn_{b}L_{c}O_{2-α}R₂ (wherein, in the above chemical formula, 0.90≦a≦1.8, 0≦b≦0.5, 0≦c≦0.05, 0<α<2); LiₐNi_{b}E_{c}G_{d}O₂ (wherein, in the above chemical formula, 0.90≦a≦1.8, 0≦b≦0.9, 0≦c≦0.5, 0.001≦d≦0.1); LiₐNi_{b}Co_{c}Mn_{d}GₑO₂ (wherein, in the above chemical formula, 0.90≦a≦1.8, 0≦b≦0.9, 0≦c≦0.5, 0≦d≦0.5, 0.001≦e≦0.1); LiₐNiG_{b}O₂ (wherein, in the above chemical formula, 0.90≦a≦1.8, 0.001≦b≦0.1); LiₐCoG_{b}O₂ (wherein, in the above chemical formula, 0.90≦a≦1.8, 0.001≦b≦0.1); LiₐMnG_{b}O₂ (wherein, in the above chemical formula, 0.90≦a≦1.8, 0.001≦b≦0.1); LiₐMn₂G_{b}O₄ (wherein, in the above chemical formula, 0.90≦a≦1.8, 0.001≦b≦0.1); LiQS₂; LiV₂O₅; LiIO₂; LiNiVO₄; Li_{(3-f)}J₂(PO₄)₃(0≦f≦2); Li_{(3-f)}Fe₂(PO₄)₃(0≦f≦2); or LiFePO₄.

In the above chemical formulae, A is Ni, Co, Mn, or a combination thereof; L is Al, Ni, Co, Mn, Cr, Fe, Mg, Sr, V, a rare earth element, or a combination thereof; D is O, F, S, P, or a combination thereof; E is Co, Mn, or a combination thereof; R is F, S, P, or a combination thereof; G is Al, Cr, Mn, Fe, Mg, La, Ce, Sr, V, or a combination thereof; Q is Ti, Mo, Mn, or a combination thereof; I is Cr, V, Fe, Sc, Y, or a combination thereof; and J is V, Cr, Mn, Co, Ni, Cu, or a combination thereof.

The positive active material may be lithium cobalt oxide, lithium nickel cobalt manganese oxide, lithium nickel cobalt aluminum oxide, or a combination thereof.

The binder improves the binding properties of the positive active material particles with one another and with a current collector, and examples thereof may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The conductive material improves the conductivity of an electrode. Any suitable electrically conductive material may be used as a conductive material, unless it causes a chemical change. Examples thereof may be one or more of natural graphite, artificial graphite, carbon black, acetylene black, ketjen black, a carbon fiber; copper; a metal powder, a metal fiber or the like of nickel, aluminum, silver, or the like; and a conductive material such as a polyphenylene derivative or the like.

The negative electrode and the positive electrode may be manufactured by a method including mixing an active material, a conductive material, and a binder into an active material composition and coating the composition on a current collector. The electrode manufacturing method is known, and thus is not described in more detail in the present specification. The solvent may include N-methylpyrrolidone or the like, but is not limited thereto.

The separator may include any suitable material commonly used in the conventional lithium battery as long as it can separate the negative electrode from the positive electrode and provide a transporting passage for lithium ions. In other words, the separator may have a low resistance to ion transportation and an excellent impregnation for an electrolyte solution. For example, it may be selected from a glass fiber, polyester, polyethylene, polypropylene, polytetrafluoroethylene (PTFE), or a combination thereof. It may have a form of a non-woven fabric or a woven fabric. For example, a polyolefin-based polymer separator such as polyethylene, polypropylene or the like may be used for a lithium ion battery. In order to ensure the heat resistance or mechanical strength, a coated separator including a ceramic component or a polymer material may be used. Selectively, it may have a mono-layered or multi-layered structure.

The separator may include a substrate and at least one coating layer positioned on one side of the substrate.

The substrate may include a polyolefin resin. The polyolefin resin may include a polyethylene-based resin, a polypropylene-based resin, or a combination thereof.

The coating layer may include a polymer. The polymer may include polyvinylidene fluoride (PVdF), a polyvinylidene fluoride-hexafluoropropylene (PVdF-HFP) copolymer, or a combination thereof. When the polymer is coated on at least one side of the substrate, the polymer is physically cross-linked with binders that are respectively present in the positive and negative electrodes, which further improves adherence between the separator and the electrodes.

The coating layer may further include an inorganic material. The inorganic material may include Al₂O₃, MgO, TiO₂, Al(OH)₃, Mg(OH)₂, Ti(OH)₄ or a combination thereof. When the inorganic material is coated on at least one side of the substrate of a separator, the substrate may be structurally prevented from directly contacting the active material layers that are respectively present in the positive and negative electrodes, and thus the battery safety may be improved. The inorganic material may have an average particle diameter from about 50 to about 500 μm.

The coating layer may further include a heat-resistance resin including an aramid resin, a polyamideimide resin, a polyimide resin, or a combination thereof.

The coating layer may have a thickness from about 1 to about 10 μm, for example, about 1 to about 8 μm. In one embodiment, when the coating layer has a thickness within the range, the coating layer accomplishes excellent heat resistance and suppresses thermal shrinkage and the elution of metal ions.

When the substrate of a separator has the coating layer on at least one side of the substrate, even when a plenty of HF is generated in an electrolyte solution during the thermal compression, since the HF is suppressed from reacting with the Si-based material by a compound represented by the above Chemical Formula 1, a high voltage rechargeable lithium battery including the separator may secure excellent cycle-life characteristics at room temperature and at high temperatures.

A rechargeable lithium battery according to one embodiment may be charged at a high voltage from about 4.0 to about 4.45 V. Even though the rechargeable lithium battery is charged within the high voltage range, excellent cycle-life characteristics at room temperature and at high temperatures may be secured.

Hereinafter, the embodiments are illustrated in more detail with reference to the following examples. However, the present disclosure is not limited thereto.

Furthermore, what is not described in this disclosure may be sufficiently understood by those who have knowledge in this field and will not be illustrated here.

### Example 1

### Manufacture of A Positive Electrode

A positive active material layer composition was prepared by mixing polyvinylidene fluoride (PVdF), carbon black, and a mixture of 80 wt % of LiCoO₂ and 20 wt % of LiNi_{0.5}Co_{0.2}Mn_{0.3}O₂, in a weight ratio of 4:4:92 and dispersing the obtained mixture in N-methyl-2-pyrrolidone. The positive active material layer composition was coated on a 20 μm-thick aluminum foil, dried, and compressed to manufacture a positive electrode.

### Manufacture of a Negative Electrode

A negative active material layer composition was prepared by mixing polyvinylidene fluoride (PVdF) and a mixture of 90 wt % of graphite and 10 wt % of Si—Fe alloy (a mole ratio of Si:Fe=4:6) (CV4, 3M) in a weight ratio of 8:92 and dispersing the resulting mixture in N-methyl-2-pyrrolidone. The negative active material layer composition was coated on a 15 μm-thick copper foil, dried, and compressed to manufacture a negative electrode.

### Preparation of an Electrolyte Solution

An electrolyte solution was prepared by mixing ethylene carbonate (EC), ethylmethyl carbonate (EMC), and diethyl carbonate (DEC) in a volume ratio of 3:5:2 to prepare a mixed solvent, dissolving 1.3 M LiPF₆ in the mixed solvent, and adding 10 parts by weight of fluoroethylene carbonate and 0.2 parts by weight of a compound represented by the following Chemical Formula 2 based on 100 parts by weight of the mixed solvent to the solution.

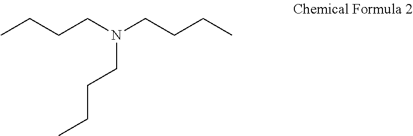

### Manufacture of a Rechargeable Lithium Battery Cell

The positive electrode and the negative electrode along with an 18 μm-thick polyethylene separator were spirally wound to manufacture an electrode assembly. Subsequently, the electrode assembly was put in a battery case, and the electrolyte solution was injected into the battery case to manufacture a rechargeable lithium battery cell.

### Example 2

A rechargeable lithium battery cell was manufactured according to the same method as Example 1 except for preparing the electrolyte solution by adding an additional 3 parts by weight of LiB(C₂O₄)F₂ based on 100 parts by weight of the mixed solvent.

### Example 3

A rechargeable lithium battery cell was manufactured according to the same method as Example 1 except for using a separator manufactured as follows.

The separator was manufactured by coating a coating material prepared by mixing 2 parts by weight of Al₂O₃ (having an average particle diameter of 200 μm) and 5 parts by weight of polyvinylidene fluoride (PVdF) based on 100 parts by weight of a substrate on one surface of the polyethylene substrate.

### Comparative Example 1

A rechargeable lithium battery cell was manufactured according to the same method as Example 1 except for adding no compound represented by the above Chemical Formula 2.

### Comparative Example 2

A rechargeable lithium battery cell was manufactured according to the same method as Comparative Example 1 except for using a separator manufactured as follows.

The separator was manufactured by coating a coating material prepared by mixing 2 parts by weight of Al₂O₃ (having an average particle diameter of 200 μm) and 5 parts by weight of polyvinylidene fluoride (PVdF) based on 100 parts by weight of a substrate on one surface of the polyethylene substrate.

### Evaluation 1: Irreversible Characteristic of Negative Electrode

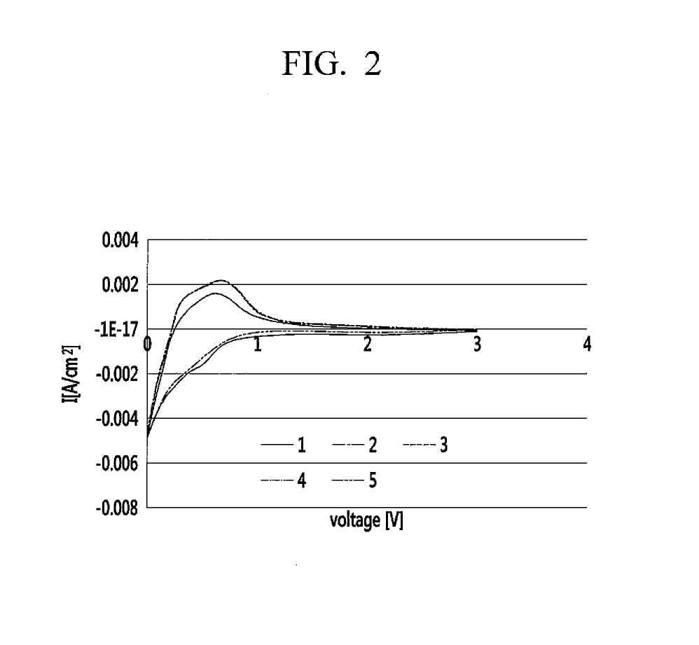

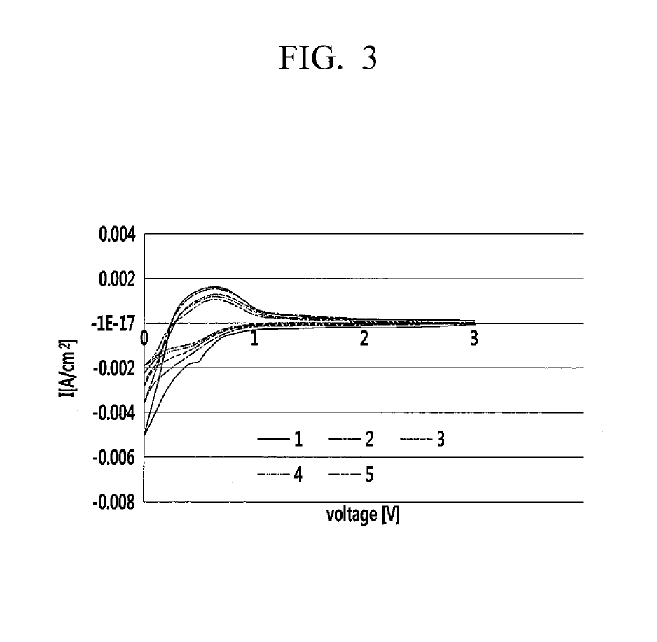

Irreversible characteristics of the negative electrodes of Example 1 and Comparative Example 1 were evaluated by using a negative electrode as a working electrode and a lithium metal as a reference electrode and a counter electrode and performing a cyclic voltammetry analysis from 0 V to 3 V at a speed of 1 mV/s, and the results are provided in FIGS. 2 and 3.

FIG. 2 is the cyclic voltammetry analysis graph of the rechargeable lithium battery cell manufactured according to Example 1, and FIG. 3 is the cyclic voltammetry analysis graph of the rechargeable lithium battery cell manufactured according to Comparative Example 1. In FIGS. 2 and 3, figures of 1 to 5 correspond to cycle numbers. Also, each cycle has (−) and (+) current values, as the each cycle is performed according to the voltage condition of 3V→0V→3V.

Referring to FIGS. 2 and 3, FIG. 3 shows that a current peak in an area from about 0 V to 1 V decreases as the number of cycle goes up, and FIG. 2 shows that a current peak in the same area reduces and eventually disappears as the number of cycle goes up. The reason is that the rechargeable lithium battery cell of Example 1 in FIG. 2 tended to suppress undesirable and irreversible reactions compared to that of Comparative Example 1 in FIG. 3.

### Evaluation 2: Cycle-Life Characteristics of Rechargeable Lithium Battery Cell

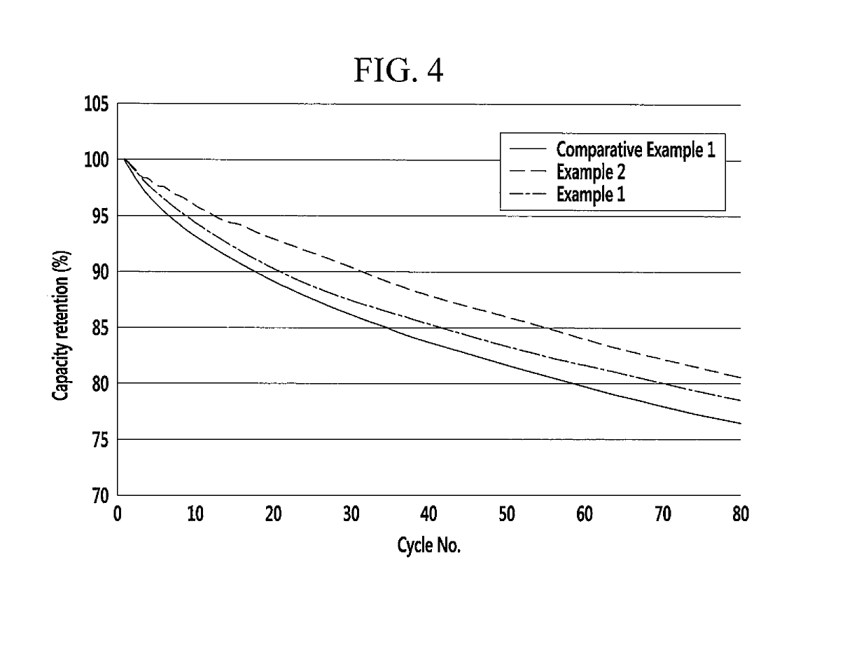

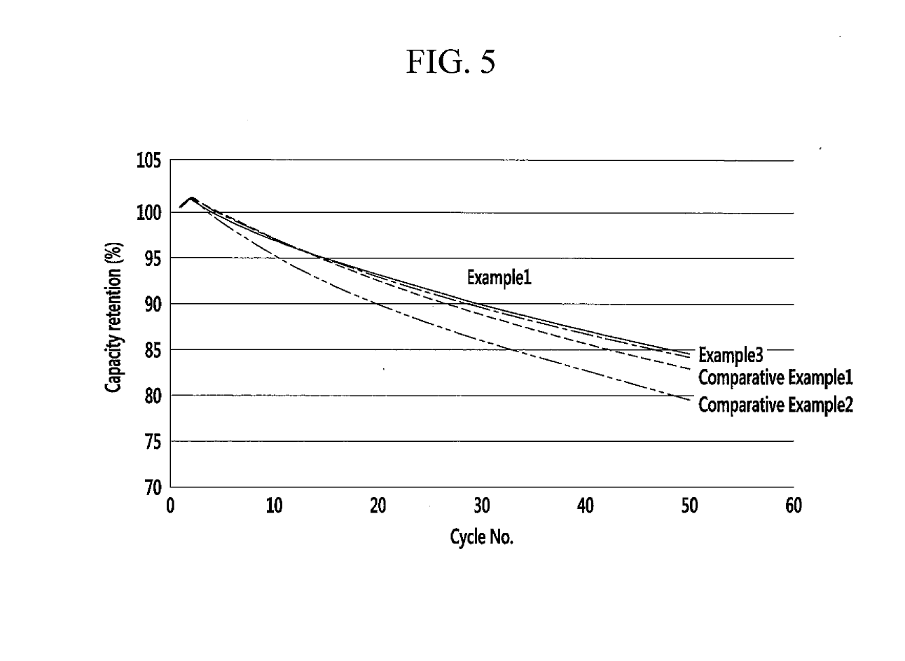

The rechargeable lithium battery cells manufactured according to Examples 1 to 3 and Comparative Examples 1 and 2 were charged at 4.4 V and 0.7 C at 45° C. and then, discharged at 2.75 V and 0.5 C. The dependency of the discharge capacity of the rechargeable lithium battery cells on the number of cycles was evaluated after 150 times repeating of this charge and discharge, and the results are provided in FIGS. 4 and 5.

FIG. 4 is a graph showing high temperature cycle-life characteristics of the rechargeable lithium battery cells manufactured according to Examples 1 and 2 and Comparative Example 1, and FIG. 5 is a graph showing high temperature cycle-life characteristics of the rechargeable lithium battery cells manufactured according to Examples 1 and 3 and Comparative Examples 1 and 2.

Herein, FIG. 4 uses a rechargeable lithium battery cells having a coin shape (capacity of about 6 mAh), and FIG. 5 uses a rechargeable lithium battery cells having a pouch shape (capacity of about 2,000 mAh).

Referring to FIG. 4, Examples 1 and 2 using an electrolyte solution including fluoroethylene carbonate and a compound represented by Chemical Formula 1 showed better cycle-life characteristics at a high temperature than Comparative Example 1 using an electrolyte solution including no compound represented by the above Chemical Formula 1. In addition, comparing Example 1 with 2, the electrolyte solution including fluoroethylene carbonate and a compound represented by Chemical Formula 1 improved high temperature cycle-life characteristics more than the electrolyte solution including LiFOB.

Referring to FIG. 5, comparing Example 3 with Comparative Example 2, both using a separator having a coating layer on at least one side of a substrate, Example 3 using an electrolyte solution including fluoroethylene carbonate and a compound represented by Chemical Formula 1 showed better cycle-life characteristics at a high temperature than Comparative Example 2 using an electrolyte solution including no compound represented by the above Chemical Formula 1.

### Evaluation 3: EDX Analysis of Negative Electrodes

The rechargeable lithium battery cells manufactured according to Example 1 and Comparative Example 1 were charged at 4.4 V and 0.7 C at 45° C., discharged at 2.75 V and 0.5 C, and then decomposed after 100 times repeating the charge and discharge. The amount of Si of the negative electrodes was analyzed, and the results are provided in the following Table 1.

TABLE 1

| | Example 1 | Comparative Example 1 |
|---|---|---|
| C (atom %) | 63.21 | 67.86 |
| O (atom %) | 16.63 | 16.57 |
| F (atom %) | 13.41 | 11.60 |
| Si (atom %) | 4.21 | 1.54 |

Referring to Table 1, Example 1 showed higher amount of Si than Comparative Example 1, since the Si-based material of the negative electrode is suppressed from reacting with HF in the electrolyte solution by the compound represented by Chemical Formula 1 in the electrolyte.

While this disclosure has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims, and equivalents thereof.

### DESCRIPTION OF SYMBOLS

100: rechargeable lithium battery
10: electrode assembly
20: battery case
13: electrode tab

What is claimed is:

1. A rechargeable lithium battery, comprising
a negative electrode comprising a negative active material, the negative active material comprising a Si-based material;
a positive electrode comprising a positive active material;
a separator between the negative electrode and the positive electrode; and
an electrolyte solution comprising a lithium salt, an organic solvent and an additive, the additive comprising fluoroethylene carbonate and a compound represented by Chemical Formula 1: 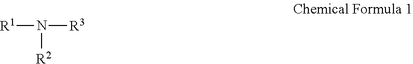
where R¹ to R³ are each independently a substituted or unsubstituted C2 to C5 alkyl group.

2. The rechargeable lithium battery of claim 1, wherein the negative active material comprises about 1 to about 70 wt % of the Si-based material based on a total amount of the negative active material.

3. The rechargeable lithium battery of claim 1, wherein the compound represented by Chemical Formula 1 is included in an amount less than about 10 parts by weight based on 100 parts by weight of the organic solvent.

4. The rechargeable lithium battery of claim 1, wherein the compound represented by Chemical Formula 1 is included in an amount from about 0.1 to about 10 parts by weight based on 100 parts by weight of the organic solvent.

5. The rechargeable lithium battery of claim 1, wherein the fluoroethylene carbonate is included in an amount from about 1 to about 10 parts by weight based on 100 parts by weight of the organic solvent.

6. The rechargeable lithium battery of claim 1, wherein the additive further comprises LiB(C₂O₄)F₂ (lithium difluorooxalatoborate, LiFOB).

7. The rechargeable lithium battery of claim 6, wherein the LiB(C₂O₄)F₂ is included in an amount from about 0.1 to about 5 parts by weight based on 100 parts by weight of the organic solvent.

8. The rechargeable lithium battery of claim 1, wherein the lithium salt is selected from LiPF₆, LiBF₄, LiSbF₆, LiAsF₆, LiN(SO₃C₂F₅)₂, LiC₄F₉SO₃, LiClO₄, LiAlO₂, LiAlCl₄, LiN(CₓF₂ₓ₊₁SO₂)(C_{y}F_{2y+1}SO₂) where x and y are natural numbers, LiCl, LiI, LiB(C₂O₄)₂ (lithiumbisoxalatoborate (LiBOB)) or a combination thereof.

9. The rechargeable lithium battery of claim 8, wherein the lithium salt is included at a concentration from about 0.1 M to about 2.0 M.

10. The rechargeable lithium battery of claim 1, wherein the Si-based material comprises Si; SiOx where x isgreater than zero and less than or equal to two; a Si-M alloy where M is an element selected from an alkali metal, an alkaline-earth metal, a Group 13 to 16 element other than Si, a transition metal, a rare earth element, or a combination thereof; a Si—C composite; or a combination thereof.

11. The rechargeable lithium battery of claim 1, wherein the separator comprises:
a substrate; and
a coating layer on at least one side of the substrate and comprising a polymer.

12. The rechargeable lithium battery of claim 11, wherein the polymer comprises polyvinylidene fluoride (PVdF), a polyvinylidene fluoride-hexafluoropropylene (PVdF-HFP) copolymer, or a combination thereof.

13. The rechargeable lithium battery of claim 11, wherein the coating layer further comprises an inorganic material.

14. The rechargeable lithium battery of claim 13, wherein the inorganic material comprises Al₂O₃, MgO, TiO₂, Al(OH)₃, Mg(OH)₂, Ti(OH)₄, or a combination thereof.

15. The rechargeable lithium battery of claim 1, wherein the rechargeable lithium battery is configured to be charged to a voltage from about 4.0 to about 4.45 V.

16. A rechargeable lithium battery, comprising:
a negative electrode comprising a negative active material, the negative active material comprising a Si-based material selected from Si; SiOx where x is greater than zero and less than or equal to two; a Si-M alloy where M is selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof; a Si—C composite; or a combination thereof;
a positive electrode comprising a positive active material;
a separator between the negative electrode and the positive electrode; and
an electrolyte solution comprising a lithium salt, an organic solvent and an additive, the additive comprising fluoroethylene carbonate and a compound represented by Chemical Formula 1: 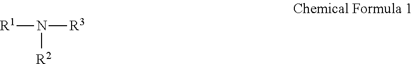
where R¹ to R³ are each independently a substituted or unsubstituted C2 to C5 alkyl group.

17. The rechargeable lithium battery of claim 16, wherein the negative active material comprises about 1 to about 70 wt % of the Si-based material based on a total amount of the negative active material.

18. The rechargeable lithium battery of claim 16, wherein the compound represented by Chemical Formula 1 is included in an amount less than about 10 parts by weight based on 100 parts by weight of the organic solvent.

19. The rechargeable lithium battery of claim 16, wherein the compound represented by Chemical Formula 1 is included in an amount from about 0.1 to about 10 parts by weight based on 100 parts by weight of the organic solvent.

20. The rechargeable lithium battery of claim 16, wherein the fluoroethylene carbonate is included in an amount from about 1 to about 10 parts by weight based on 100 parts by weight of the organic solvent.
